(19) United States
(12) Patent Application Publication
(10) Pub. No.: US 2025/0312244 A1
(43) Pub. Date: Oct. 9, 2025

(54) Hands-Free Medication Dispensing System with Dial-Forward Mechanism

(71) Applicant: Paulette Lynch, Wilmington, NC (US)

(72) Inventor: Paulette Lynch, Wilmington, NC (US)

(21) Appl. No.: 19/014,379

(22) Filed: Jan. 9, 2025

Related U.S. Application Data
(60) Provisional application No. 63/574,301, filed on Apr. 4, 2024.

(51) Int. Cl. A61J 7/04

(52) U.S. Cl. CPC A61J 7/0445; A61J 7/0454

(57) ABSTRACT

The present invention is a hands-free medication dispensing device for the accurate administration and management of medications, particularly narcotics (i.e., Suboxone and Subutex). The device comprises at least one pill holder integrated with a dial-forward member operable to dispense a single pill per rotation. A numerical indicator updates the pill count with each activation. The device includes a planar tray with an aperture for directing dispensed pills into a receptacle positioned under the tray. In one embodiment, a narcotic dispensing system is configured with four towers, each designed to store pills of varying dosages. Each tower features an independent dial-forward member, enabling controlled, individual pill dispensing. An integrated labeling system accommodates bottles and enables automated label application for efficient clinic workflows.

### CROSS-REFERENCE TO RELATED APPLICATION

The present application claims priority to, and the benefit of, U.S. Provisional Application No. 63/574,301 which was filed on Apr. 4, 2024, and is incorporated herein by reference in its entirety.

### FIELD OF THE INVENTION

The present invention generally relates to medication dispensing systems. More specifically, the invention relates to a hands-free medication dispensing device designed to improve the accuracy, efficiency, and hygiene of medication administration. The system comprises one or more pill holders integrated with a dial-forward mechanism for controlled dispensing of pills. Each holder is equipped with a numerical indicator for real-time tracking of the remaining pill count. The system includes a planar tray with an aperture that directs dispensed pills into a receptacle, such as a bottle or cup, positioned below. In some embodiments, the system features a multi-tower configuration for accommodating different medications or dosages, with each tower operating independently. Accordingly, the present disclosure makes specific reference. Nonetheless, it is to be appreciated that aspects of the present invention are also equally applicable to other like applications, devices, and methods of manufacture.

### BACKGROUND

By way of background, substance abuse medications play an important role in addressing the global challenge of addiction, particularly to opioids and other substances. These medications, such as Suboxone and Subutex are integral components of medication-assisted treatment (MAT) programs, which combine pharmacological interventions with counseling and behavioral therapies to support recovery. Commonly, such medication pills are traditionally distributed by hand, that can result in hygiene concerns, including the transfer of germs between medical staff and patients. The manual handling also increases the risk of inaccuracies in pill counts, leading to errors in dosing and potential medication wastage. Furthermore, manual counting requires clinical staff to repeatedly count pills throughout their shift to ensure accuracy, consuming valuable time and resources that could otherwise be allocated to patient care. Inefficiencies in the conventional way of handling and distributing substance abuse medications highlight the need for a system that provides accurate dispensing and handling of substance abuse medications.

Therefore, there exists a long-felt need in the art for a hands-free medication dispensing system that provides accurate administration and tracking of medications. There is a long-felt need for a system that eliminates the risk of contamination during the dispensing process and reduces manual handling of medications. Additionally, there is a long-felt need for a dispensing device that minimizes the possibility of medication wastage or miscounting of pills. Furthermore, there is a long-felt need for a device that integrates medication labeling to streamline operations and improve efficiency in substance abuse clinics. More specifically, there exists a long-felt need for an improved dispensing system that can accommodate multiple medications and dosages. Finally, there exists a long-felt need in the art for a portable, secure, and user-friendly system that simplifies medication dispensing and management in clinical environments.

The subject matter disclosed and claimed herein, in one embodiment, comprises a hands-free medication dispensing device for clinical use. The device includes at least one pill holder integrated with a dial-forward mechanism that releases a single pill per rotation. The dial-forward mechanism includes a numerical indicator to track the remaining pill count in real time. The system features a planar tray with an aperture for directing dispensed pills into a receptacle such as a bottle or cup. In some embodiments, the system comprises multiple pill holders, including a four-tower configuration for dispensing medication pills (i.e., Suboxone pills) of varying dosages. Each tower is equipped with an independent dial-forward mechanism.

In this manner, the hands-free medication dispensing device of the present invention accomplishes all of the foregoing objectives and provides a practical solution for clinical medication management. The device simplifies and automates the dispensing process, reducing the risk of contamination and manual errors. The dial-forward mechanism provides accurate counting and minimizes the risk of wastage or overdosing. The labeling system streamlines operations and enhances the accuracy of medication identification. The four-tower configuration enables the dispensing of multiple medications or dosages simultaneously. The system is portable and secure, thereby provides compliance with clinical safety standards while being user-friendly and efficient for healthcare workers.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hands-free medication dispensing device. The device comprises at least one pill holder configured to store a plurality of pills, a dial-forward member is integrated with the pill holder, the dial-forward member is operable to release a single pill per activation, a tray is positioned below the pill holder, the tray has an aperture for directing dispensed pills into a receptacle, and a numerical indicator is associated with the dial-forward member for tracking the remaining pill count in the holder, wherein the numerical indicator updates with each activation of the dial-forward member.

In another aspect, a medication dispensing system for hands-free administration of narcotics (i.e., Subutex) is disclosed. The system includes a first pill holder and a second pill holder, each configured to store a predetermined number of pills, a dial-forward member is integrated into each pill holder, the dial-forward member is operable to dispense one pill per rotation and to decrement a displayed pill count, a planar tray is positioned beneath the pill holders, the tray includes an aperture for directing dispensed pills into a bottle or cup, a cup holder is disposed below the aperture for securely holding the bottle or cup in place during dispensing, and a labeling system comprises a circular holder for accommodating a bottle and an integrated printer for applying medication labels.

In another embodiment, a method of dispensing and managing medications using a Suboxone and Subutex dispensing device is disclosed. The method includes the steps of placing pills into at least one pill holder of the dispensing device, setting a dial-forward member integrated into the pill holder to reflect the total number of pills loaded, activating the dial-forward member to dispense a single pill through an aperture in a tray positioned below the pill holder, collecting the dispensed pill in a receptacle secured in a cup holder beneath the tray, updating a numerical indicator associated with the dial-forward member to reflect the remaining pill count in the pill holder, and printing and applying a label to the receptacle using an integrated labeling device.

In one embodiment, the dial-forward member is configured to rotate forward in incremental notches, each notch corresponding to the release of one pill.

In another aspect, the dial-forward member includes a pre-calibration feature to recognize the total number of pills loaded into the pill holder prior to dispensing.

In still another embodiment, the rotation of the dial-forward member causes a physical barrier or gate to momentarily open, enabling a single pill to drop through the tray aperture.

In yet another embodiment, the system includes four holders, each holder is configured to store medication pills (i.e., Suboxone pills) of varying dosages, the holders are mounted on a common planar tray. Each tower is equipped with an individual dial-forward member, each dial member is operable independently to dispense a pill from its respective tower.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of hands-free medication dispensing device of the present invention in accordance with the disclosed architecture;

FIG. 2 illustrates a perspective view showing medication pills (i.e., Subutex pills) being dispensed from the pill-containing holders of FIG. 1 in accordance with one embodiment of the present invention;

FIG. 3 illustrates a perspective view of medication dispenser system of the present invention in accordance with one embodiment of the disclosed structure;

FIG. 4 illustrates a flow chart depicting a process of using the medication dispensing system of different embodiments of the present invention in accordance with the disclosed structure; and

FIG. 5 illustrates a perspective view of a labeling device used in the system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a hands-free medication dispensing system that provides accurate administration and tracking of medications. There is a long-felt need for a system that eliminates the risk of contamination during the dispensing process and reduces manual handling of medications. Additionally, there is a long-felt need for a dispensing device that minimizes the possibility of medication wastage or miscounting of pills. Furthermore, there is a long-felt need for a device that integrates medication labeling to streamline operations and improve efficiency in substance abuse clinics. More specifically, there exists a long-felt need for an improved dispensing system that can accommodate multiple medications and dosages. Finally, there exists a long-felt need in the art for a portable, secure, and user-friendly system that simplifies medication dispensing and management in clinical environments.

The present invention, in one exemplary embodiment, is a method of dispensing and managing medications using a medication (i.e., Suboxone and Subutex) dispensing device. The method includes the steps of placing pills into at least one pill holder of the dispensing device, setting a dial-forward member integrated into the pill holder to reflect the total number of pills loaded, activating the dial-forward member to dispense a single pill through an aperture in a tray positioned below the pill holder, collecting the dispensed pill in a receptacle secured in a cup holder beneath the tray, updating a numerical indicator associated with the dial-forward member to reflect the remaining pill count in the pill holder, and printing and applying a label to the receptacle using an integrated labeling device.

Reference will now be made in detail to the present preferred embodiments of the invention, examples of which are illustrated in the accompanying drawings. Wherever possible, the same reference numerals are used in the drawings and the description to refer to the same or like parts.

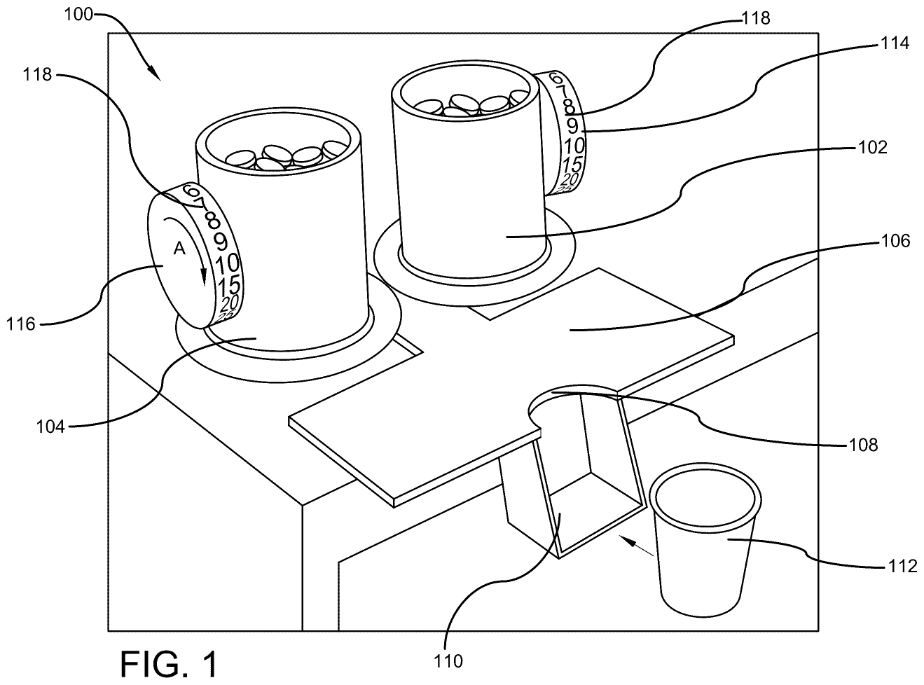

Referring initially to the drawings, FIG. 1 illustrates a perspective view of one potential embodiment of hands-free medication dispensing device of the present invention in accordance with the disclosed architecture. The hands-free medication dispensing device 100 of the present invention is designed for the accurate administration and management of medications and specifically, Suboxone and Subutex medications, which are commonly used in substance abuse treatment clinics. The hands-free medication dispensing device 100 is adapted to provide an accurate count of the pills dispensed throughout the dispensing process, thereby enhancing medication tracking and reducing errors.

More specifically, the hands-free medication dispensing device 100 of the present embodiment includes a first medication dispensing container 102 and a second medication dispensing container 104. The containers 102, 104 are preferably designed in the form of dial-up pill holders and are positioned on the top of a planar tray 106. The tray 106 includes an aperture 108 below which a cup holder 110 in the form of a metal or plastic grid is disposed. A cup 112 can be removably positioned in the cup holder 110 for catching the medication pills (i.e., Subutex and Suboxone pills) dispensed from the containers 102, 104 and dropped through the aperture 108.

Each pill containing holder of the containers 102, 104 includes an integrated dial-forward member for enabling tracking of the dispensed pills. As illustrated, the container 102 includes the first dial-forward member 114 and the second container 104 includes the second dial-forward member 116. Each dial-forward member includes a plurality of numerical indicators 118 wherein the numerical indicators represent the pill count in the respective container/holder. When a user rotates or advances the integrated dial-forward member 114, 116 forward as indicated by arrow A, a single pill is released into the dispensing tray 106 and directly into the bottle/cup 112 placed in the cup holder 110. The dial-forward members 114, 116 ensures that only one pill is released per action, preventing overdosing or wastage.

It should be noted that each time the dial-forward member is moved forward, the displayed count decreases by one, reflecting the number of pills remaining in the corresponding holder or container. Both the containers 102, 104 and the dial-forward members 114, 116 are made from lightweight and durable materials like plastic and metal. As an example, a user may load “30” medication pills (i.e., Subutex and Suboxone pills) in one container and may set the dial-forward member to “30”. Then, the user may rotate the dial forward by one notch (one numerical) to dispense one pill from the container and the count on the dial reduces by one to “29”.

As an example, when a dose of medication is required, medical staff may turn dial of a container to dispense a pill. As the pill is dispensed, the pill drops through the hole or aperture 108 of the tray 106 into a bottle or cup 112. To avoid contamination, a tongue blade or similar tool (not shown) is used to guide the pills into the bottle or cup without direct handling.

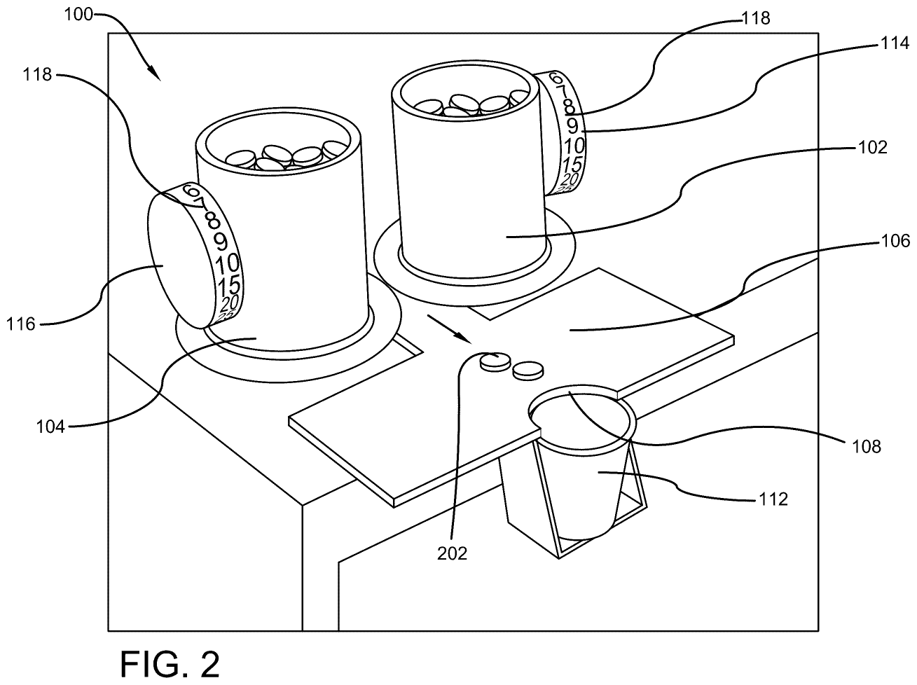

FIG. 2 illustrates a perspective view showing Medication pills (i.e., Subutex and Suboxone pills) being dispensed from the pill-containing holders of FIG. 1 in accordance with one embodiment of the present invention. As illustrated, for using the system 100, the system 100 is placed on a table and any appropriate medication is loaded into the containers 102, 104. Further, the dial-forward members 114, 116 are preset with the total number of pills loaded in the containers 102, 104. For dispensing, one or both dial-forward members 114, 116 are turned to dispense the pills 202 into the cup 112. The hands-free dispensing and integrated labeling in the system 100 reduce manual labor and time spent on dispensing. After use, the system 100 can be removed from the table and placed in a secure safe for storage.

In some embodiments, the dial members may be pre-calibrated to recognize the total number of pills loaded, either manually or through an automated process. Further, the containers 102, 104 include physical barriers or gates coupled to a notch of the dial member and are adapted to open momentarily to enable one pill to drop.

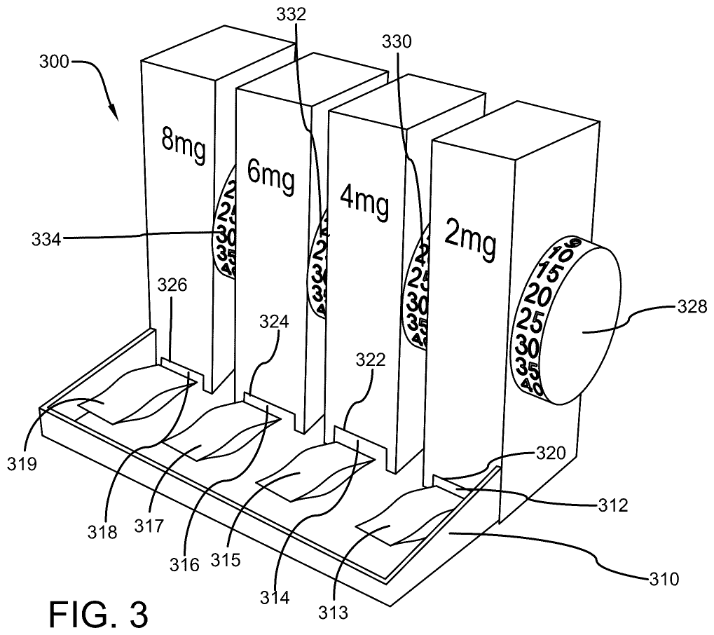

FIG. 3 illustrates a perspective view of medication dispenser system of the present invention in accordance with one embodiment of the disclosed structure. The medication dispenser system 300 includes a plurality of towers or holders 302, 304, 306, 308, wherein each holder is disposed on a mounting tray 310. Each holder includes a dispensing slot disposed at the bottom end of the tower. As illustrated, the dispensing slots 312, 314, 316, 318 are disposed at the bottom ends 320, 322, 324, 326 of the holders 302, 304, 306, 308. An individual receiving package 313, 315, 317, 319 can be placed proximal to each of the dispensing slots 312, 314, 316, 318 for receiving a dispensed medication.

Each holder includes a corresponding dial member for dispensing medications therefrom. As shown, the holders 302, 304, 306, 308 have dial members 328, 330, 332, 334 respectively, wherein the dial members can be moved or turned forward to dispense one dose of medication from the respective holder. Each tower or holder is configured to store medication pills (i.e., Suboxone or Subutex pills) of varying dosages such as holders 302, 304, 306, 308 store Suboxone of 2 mg, 4 mg, 8 mg, and 12 mg respectively.

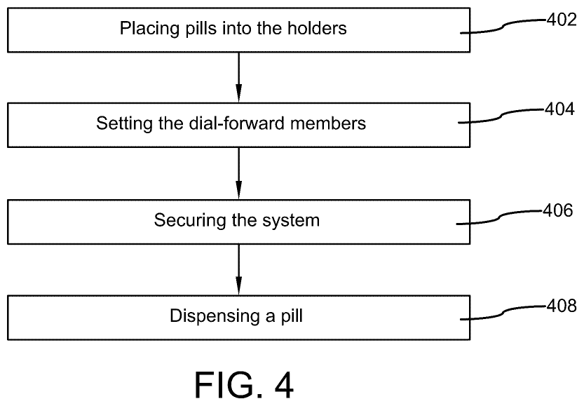

FIG. 4 illustrates a flow chart depicting a process of using the medication dispensing system of different embodiments of the present invention in accordance with the disclosed structure. Initially, the desired number of medication pills (i.e., Suboxone or Subutex pills) are placed into their respective dispensing towers or holders (Step 402). Preferably, the pill count matches the preset capacity such as 30 pills of the holder. Then, the dial-forward members are set to reflect the total count of pills loaded into each holder (Step 404). Thereafter, the system is placed securely on a flat surface for use (Step 406) and in some embodiments, the bottom surface of the tray may include a magnet for secure magnetic attachment on any metal surface. Finally, at least one dial-forward member is rotated to dispense one pill into a cup (Step 408).

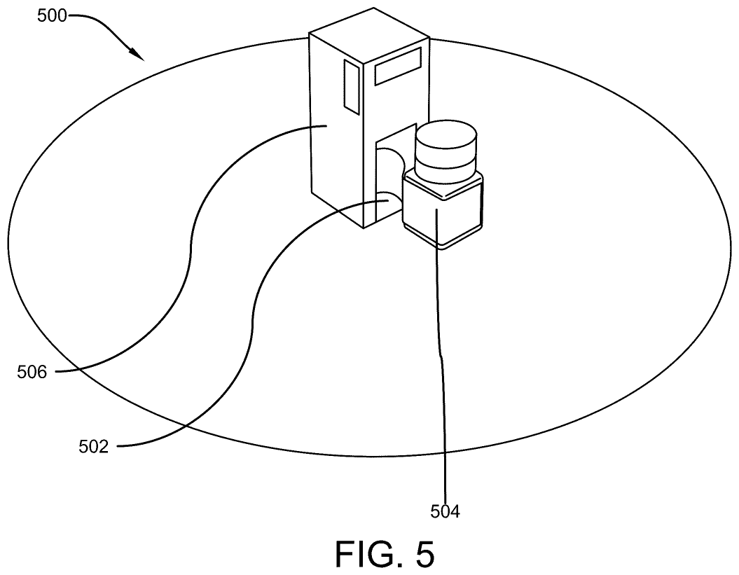

FIG. 5 illustrates a perspective view of a labeling device used in the system of the present invention in accordance with the disclosed structure. The medication dispensing system of the present invention uses a labeling system 500 which includes a slot 502 for accommodating a bottle 504. The bottle 504 containing pills is placed into the circular holder 506 of the system 500 and the system 500 prints the bottle 504 with the medication label.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hands-free medication dispensing device”, “Suboxone dispensing system,”, “Suboxone and Subutex dispensing device”, “medication dispensing system”, “and “system” are interchangeable and refer to the hands-free medication dispensing device 100, 300 of the present invention.

Notwithstanding the forgoing, the hands-free medication dispensing device 100, 300 of the present invention can be of any suitable size and configuration as is known in the art without affecting the overall concept of the invention, provided that it accomplishes the above stated objectives. One of ordinary skill in the art will appreciate that the hands-free medication dispensing device 100, 300 as shown in the FIGS. are for illustrative purposes only, and that many other sizes and shapes of the hands-free medication dispensing device 100, 300 are well within the scope of the present disclosure. Although the dimensions of the hands-free medication dispensing device 100, 300 are important design parameters for user convenience, the hands-free medication dispensing device 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hands-free medication dispensing device comprising:
a first medication dispensing container;
a second medication dispensing container;
a tray;
a cup holder; and
a cup;
wherein said first medication dispensing container is a first pill holder;
wherein said second medication dispensing container is a second pill holder;
wherein said first medication dispensing container having a first dial forward member for tracking a first count of pills dispensed from said first medication dispensing container;
wherein said second medication dispensing container having a second dial forward member for tracking a second count of pills dispensed from said second medication dispensing container;
wherein said tray having an aperture; and
further wherein said cup removably positioned in said cup holder for receiving through said aperture a pill dispensed from said first medication dispensing container and said second medication dispensing container.

2. The hands-free medication dispensing device of claim 1, wherein said tray is a planar tray.

3. The hands-free medication dispensing device of claim 2, wherein said cup holder is mounted below said tray.

4. The hands-free medication dispensing device of claim 3, wherein said first dial forward member having a first numerical indicator for indicating said first count of pills.

5. The hands-free medication dispensing device of claim 4, wherein said second dial forward member having a second numerical indicator for indicating said second count of pills.

6. The hands-free medication dispensing device of claim 5, wherein said first dispensing container having a first gate coupled to a plurality of notches of said first dial forward member, and further wherein said first gate opens for receiving a single pill with each notched rotation of said plurality of notches of said first dial forward member.

7. The hands-free medication dispensing device of claim 6, wherein said second dispensing container having a second gate coupled to a plurality of notches of said second dial forward member, and further wherein said second gate opens for receiving another single pill with each notched rotation of said plurality of notches of said second dial forward member.

8. The hands-free medication dispensing device of claim 7, wherein said single pill and said another single pill releasable into said dispensing tray and slidable into said cup.

9. A hands-free medication dispensing device comprising:
a plurality of medication dispensing containers;
a plurality of dispensing slots;
a tray; and
a plurality of receiving packages;
wherein each of said plurality of medication dispensing containers is a medication pill container;
wherein said each of said plurality of medication dispensing containers having a dial forward member for tracking a count of medication pills dispensed from said each of said plurality of medication dispensing containers; and
further wherein one of said plurality of receiving packages proximal to a dispensing slot of said each of said plurality of medication dispensing containers for receiving a medication pill dispensed from a respective said each of said plurality of medication dispensing containers.

10. The hands-free medication dispensing device of claim 9, wherein said tray is a planar tray.

11. The hands-free medication dispensing device of claim 9, wherein each of said dial forward member having a numerical indicator for indicating said count of medication pills.

12. The hands-free medication dispensing device of claim 9, wherein said each of said plurality of medication dispensing containers having a gate coupled to a plurality of notches of said dial forward member, and further wherein said gate opens for receiving a single medication pill with each notched rotation of said plurality of notches of said dial forward member.

13. The hands-free medication dispensing device of claim 9, wherein said each of said plurality of medication dispensing containers having a different dosage of said medication pill.

14. A method of hands-free medication dispensing, the method comprising the steps of:
providing a first medication dispensing container, a second medication dispensing container, a tray, a cup holder, and a cup, wherein said first medication dispensing container is a first pill holder, wherein said second medication dispensing container is a second pill holder, further wherein said tray having an aperture;
tracking a first count of pills dispensed from said first medication dispensing container, wherein said first medication dispensing container having a first dial forward member;
tracking a second count of pills dispensed from said second medication dispensing container, wherein said second medication dispensing container having a second dial forward member; and
removably positioning said cup in said cup holder for receiving through said aperture a pill dispensed from said first medication dispensing container and said second medication dispensing container.

15. The method of hands-free medication dispensing of claim 14, wherein said tray is a planar and magnetic tray for securing to a table surface.

16. The method of hands-free medication dispensing of claim 15, wherein said cup holder is mounted below said tray.

17. The method of hands-free medication dispensing of claim 16, wherein said first dial forward member having a first numerical indicator for indicating said first count of pills, and further wherein said second dial forward member having a second numerical indicator for indicating said second count of pills.

18. The method of hands-free medication dispensing of claim 17, wherein said first dispensing container having a first gate coupled to a plurality of notches of said first dial forward member, and further wherein said first gate opens for receiving a single pill with each notched rotation of said plurality of notches of said first dial forward member.

19. The method of hands-free medication dispensing of claim 18, wherein said second dispensing container having a second gate coupled to a plurality of notches of said second dial forward member, and further wherein said second gate opens for receiving another single pill with each notched rotation of said plurality of notches of said second dial forward member.

20. The method of hands-free medication dispensing of claim 19, wherein said single pill and said another single pill releasable into said dispensing tray and slidable into said cup.
